(19) United States
(12) Patent Application Publication
(10) Pub. No.: US 2013/0297177 A1
(43) Pub. Date: Nov. 7, 2013

(54) METHOD FOR DIAGNOSING FUEL TANK LEAKS, AND APPARATUS APPLYING SAME

(71) Applicants: Han Cin Kim, Seoul (KR); Yong Joon Son, Gyeonggi-do (KR)

(72) Inventors: Han Cin Kim, Seoul (KR); Yong Joon Son, Gyeonggi-do (KR)

(73) Assignee: CONTINENTAL AUTOMOTIVE GMBH, Hannover (DE)

(21) Appl. No.: 13/821,151

(22) PCT Filed: Sep. 2, 2011
(86) PCT No.: PCT/KR11/06516

§ 371 Date: Mar. 20, 2013

(30) Foreign Application Priority Data
Sep. 6, 2010 (KR) 10-2010-0087133

(51) Int. Cl. F02D 45/00

(52) U.S. Cl. CPC F02D 45/00
USPC 701/102

(57) ABSTRACT

An apparatus and a method for diagnosing the leak of a fuel tank are disclosed. The leak of the fuel tank is immediately diagnosed when a vehicle is stopped by controlling the pressure of the fuel tank during the driving of the vehicle. Even if negative pressure is not formed when the vehicle is stopped, or the diagnosis rate of the fuel tank has to be increased, the leak of the fuel tank is able to be easily diagnosed.

### PRIORITY CLAIM

This is a U.S. national stage of International Application No. PCT/KR2011/006516, filed on 2 Sep. 2011, which claims priority to Korean Application No. 10 2010 0087133, filed 6 Sep. 2010, the contents of which are incorporated herein by reference in its entirety.

### BACKGROUND OF THE INVENTION

1. Field of the Invention

The present invention relates to an apparatus and a method for diagnosing a leak of a fuel tank. More particularly, the present invention relates to an apparatus and a method of diagnosing the leak of a fuel tank, capable of controlling the pressure of a fuel tank during the driving of a vehicle and immediately diagnosing the leak of the fuel tank when the vehicle is stopped.

2. Description of the Related Art

In general, fuel tank leaks are diagnosed by examining the increase in degree of the internal pressure of the fuel tank in the state that the fuel tank is closed after a negative pressure is formed in the fuel tank when a vehicle is stopped.

However, if the negative pressure cannot be formed when the vehicle is stopped, or the diagnosis rate of the fuel tank must be increased due to other conditions, the leak of the fuel tank cannot be properly diagnosed through the conventional technology.

### SUMMARY OF THE INVENTION

An object of the present invention is to provide an apparatus for and a method of diagnosing the leak of a fuel tank, capable of immediately diagnosing the leak of the fuel tank when a vehicle is stopped by controlling the pressure of the fuel tank during the driving of the vehicle.

In order to accomplish this above object, there is provided a method of diagnosing leak of a fuel tank that determines satisfaction of a first condition used to check a status of basic parameters required to control a pressure of the fuel tank during driving of a vehicle, and determines the satisfaction of a second condition to determine whether a pressure control operation of the fuel tank is started if the first condition is satisfied. The method further involves, adjusting a target pressure value of the fuel tank according to a driving condition of the vehicle if the second condition is satisfied, and controlling formation of the pressure to the target pressure value, by an apparatus for diagnosing the leak of the fuel tank.

Preferably, the method further includes starting a diagnosing of the leak of the fuel tank based on the pressure of the fuel tank when the vehicle is stopped in order to diagnose the leak of the fuel tank.

Preferably, the first condition includes, determining at least one of the following various conditions if errors occur in devices to diagnose the leak of the fuel tank, if fuel is cooled, if an external temperature condition is satisfied when an engine is started, if a battery voltage is effective, if an amount of the fuel is effective, and if the fuel is supplied.

Preferably, the second condition includes determining at least one of the following various conditions: if opening of a canister purge valve is controlled step by step, if the canister purge valve is at a maximum open level, if the pressure of the fuel tank is in a preset allowable range, if the pressure of the fuel tank is changed in a preset variation range, and if engine load is excessively formed to above a preset level.

Preferably, in the controlling formation of the pressure, if the pressure of the fuel tank is greater than the target pressure value, the canister purge valve is open so that the pressure of the fuel tank is reduced.

Preferably, in the controlling formation of the pressure, if the pressure of the fuel tank is lower than the target pressure value, the canister cut off valve is open, so that the pressure of the fuel tank is increased.

Preferably, in the controlling formation of the pressure, if the pressure is within a hysteresis based on the target pressure value, an open control operation of a canister purge valve or a canister cut off value is not performed and if the pressure is out of the hysteresis based on the target pressure value, the open control operation of the canister purge valve or the canister cut off value is performed.

Preferably, the driving condition includes at least one of a vehicle speed, an amount of intake air, and engine load.

Preferably, when diagnosing the leak of the fuel tank, the diagnosing the leak of the fuel tank is held until a canister purge value is open so that the pressure of the fuel tank reaches the target pressure value, if the pressure of the fuel tank is not reduced to the target pressure value, which is set corresponding to the stop of the vehicle, when the vehicle is stopped.

In another aspect of the present invention, there is provided an apparatus for diagnosing a leak of a fuel tank which includes a first determining part determining satisfaction of a first condition used to check a status of basic parameters required to control a pressure of the fuel tank during driving of a vehicle, a second determining part determining the satisfaction of a second condition to determine whether a pressure control operation of the fuel tank is started if the first condition is satisfied, an adjusting part adjusting a target pressure value of the fuel tank according to driving conditions of the vehicle if the second condition is satisfied, and a controller controlling the fuel tank to form the pressure thereof to the target pressure value.

Preferably, the apparatus further includes a diagnosing part which starts diagnosing the leak of the fuel tank based on the pressure of the fuel tank when the vehicle is stopped.

As described above, according to the present invention, the leak of the fuel tank is immediately diagnosed when a vehicle is stopped by controlling the pressure of the fuel tank during the driving of the vehicle. Accordingly, even if the negative pressure cannot be formed when the vehicle is stopped, or the diagnosis rate of the fuel tank must be increased, the leak of the fuel tank can be easily diagnosed.

### BRIEF DESCRIPTION OF THE DRAWINGS

FIG. 1 is a view showing the structure of an apparatus for diagnosing the leak of a fuel tank according to one embodiment of the present invention.

FIG. 2 is a block diagram showing the structure of the apparatus for diagnosing the leak of the fuel tank of FIG. 1 according to one embodiment of the present invention.

FIG. 3 is a flowchart showing the operating procedure of the apparatus for diagnosing the leak of the fuel tank according to one embodiment of the present invention.

### DETAILED DESCRIPTION OF THE PREFERRED EMBODIMENTS

Hereinafter, an apparatus for diagnosing the leak of a fuel tank 100 according to an exemplary embodiment of the present invention will be described with reference to accompanying drawings in more detail.

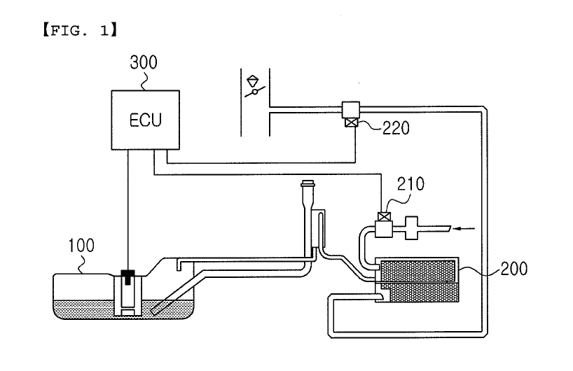

FIG. 1 is a view showing the structure of the apparatus for diagnosing the leak of the fuel tank 100 according to one embodiment of the present invention.

As shown in FIG. 1, the structure of diagnosing the leak of the fuel tank 100 includes the fuel tank 100 to store fuel to be supplied to a vehicle for the purpose of the operation of the vehicle, a sensor to measure a pressure value in the fuel tank 100, a combustion chamber to combust fuel injected under the operation of a fuel injection system, a canister 200 acting as an evaporated gas controller to collect evaporated gas to prevent the gas from being released into the atmosphere, and transfer the evaporated gas to the combustion chamber through an intake manifold if an engine is started, so that the evaporated gas is combusted together with the fuel in the combustion chamber, a canister purge valve 220 provided in a pipe connecting the combustion chamber with the canister 200 to control the evaporated gas collected in the canister 200 to be discharged to the combustion chamber, a canister cut off valve to increase the internal pressure of the fuel tank 100, and an electronic control unit 300 to control the opening/closing of the canister purge valve 220 or the canister cut off valve 210 based on fuel-related parameters such as the collection degree of the evaporated gas in the canister 200, or an internal pressure value of the fuel tank 100.

In this case, the electronic control unit 300 acts as a diagnosing device to control the pressure of the fuel tank 100 during the driving of a vehicle and immediately diagnose the leak of the fuel tank 100 when the vehicle is stopped.

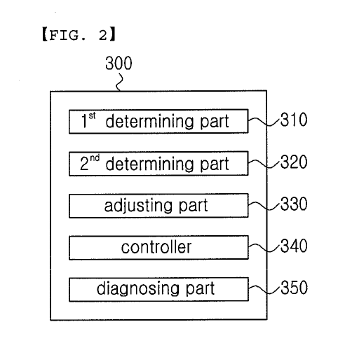

FIG. 2 is a block diagram showing the structure of the apparatus for diagnosing the leak of the fuel tank of FIG. 1 according to one embodiment of the present invention. As shown in FIG. 2, the apparatus for diagnosing the leak of the fuel tank includes a first determining part 310 to determine the satisfaction of a first condition used to check the status of basic parameters (e.g., the temperature condition of a cooling water when an engine is stopped, the temperature condition of a cooling water when the engine is started, the elapsed time when the engine is stopped, the temperature condition for air intake when the engine is stopped, the temperature condition when the engine is started, the temperature condition of engine oil when the engine is stopped, the temperature condition of the engine oil when the engine is started, the temperature conditions of the external atmosphere when the engine is stopped, and the temperature conditions of the external atmosphere when the engine is started), a second determining part 320 to determine the satisfaction of a second condition to determine whether the pressure control of the fuel tank 100 is started if the first condition is satisfied, an adjusting part 330 to adjust a target pressure value of the fuel tank 100 according to the driving conditions of a vehicle if the second condition is satisfied, and a controller 340 to control the fuel tank 100 to form the pressure thereof to the target pressure value set in the adjusting part 330.

Further, the apparatus for diagnosing the leak of the fuel tank further includes a diagnosing part 350 to start diagnosing the leak of the fuel tank 100 based on the pressure of the fuel tank 100 when the vehicle is stopped after the pressure of the fuel tank 100 has been controlled during the driving the vehicle through the above structure.

In this case, the logic of starting and stopping diagnosing the leak of the fuel tank 100 by the diagnosing part 350 when the vehicle is stopped can be performed in parallel to existing processes.

The first condition is used to properly determine related matters before the procedure of controlling the pressure of the fuel tank 100 while the driving of the vehicle is started. The first condition includes at least one of various conditions to determine if errors occur in devices, such as the canister purge valve 220, the canister cut off valve 210, the pressure sensor of the fuel tank 100, and the level sensor of the fuel tank 100, related to leak of the fuel tank 100, if fuel is sufficiently cooled (it can be determined based on the temperatures when the engine is started or stopped and the elapse time after the engine has been stopped), if external air is proper when the engine is started, if a battery. voltage is proper (e.g., 10V<voltage<16V), if an amount of fuel is proper, and if new fuel is supplied.

In addition, the second condition is used to determine a time point to start the procedure of controlling the pressure of the fuel tank 100 in order to diagnose the leak of the fuel tank 100 when the vehicle is stopped. The second condition includes at least one of various conditions to determine if the opening of the canister purge valve 220 is controlled step by step, if the canister purge valve 220 is in the maximum open state, if the pressure of the fuel tank 100 is in the allowable range, if the pressure of the fuel tank 100 is stably maintained, and if the engine is overloaded.

The first determining part 310 preferably performs an initial process to diagnose the leak of the fuel tank 100 after related temperature conditions are checked if the engine is started, so that the sufficient cooling of the fuel tank 100 is confirmed. If the temperature variation from the engine stop to the engine re-ignition exceeds the allowable range, the first condition may be set to determine that the engine is sufficiently cooled, so that the fuel in the fuel tank 100 is sufficiently cooled.

In addition, although the engine is sufficiently cooled, if fuel is injected, a great amount of evaporated gas is filled in the fuel tank 100 for a considerable amount of time. Accordingly, if refueling is detected, the diagnosing of a leak should be prevented for a considerable amount of time until the evaporated gas filled in the fuel tank 100 is sufficiently removed. It may be determined that refueling has been performed when the engine is stopped if a difference between a fuel level at a time point when the engine is stopped and a fuel level at a time point when the engine is started is higher than an allowable value.

In addition, the second condition includes the condition to determine if the canister purge valve 220 is open step by step. If a condition in which the operation of the canister purge value 220 is started under sufficient stability is not satisfied, engine hesitation may occur due to the evaporated gas contained in the intake air.

The open degree of the canister purge valve 220 varies according to the status of the vehicle. The internal pressure of the fuel tank 100 is reduced to the relative pressure of about −15 hPa when a vehicle is stopped, and the target pressure may vary according to the speed of the vehicle during the driving of the vehicle.

Accordingly, the pressure of the fuel tank 100 is maintained to a high relative pressure during the driving of the vehicle, and the pressure of the fuel tank 100 is lowered to a low target pressure when the vehicle is stopped. Therefore, since the high relative pressure can be maintained during the driving of the vehicle, the evaporated gas can be prevented from being generated in the fuel tank 100. In addition, even if the pressure of the fuel tank 100 is maintained for a long time, the fuel tank 100 can be prevented from being damaged.

In summary, in order to start diagnosing the leak of the fuel tank 100 under a condition in which a vehicle is stopped, the adjusting part 330 adjusts the internal target pressure value of the fuel tank 100 based on the speed of the vehicle, an amount of intake air, or engine load such that the internal pressure of the fuel tank 100 is reduced to about −18 hPa when the vehicle is stopped.

Regarding the following operation of the controller 340, in order to reduce the internal pressure of the fuel tank 100, the canister purge valve 220 is open the canister purge valve 220 is open, the gas in the fuel tank 100 is sucked into the intake manifold, so that the internal pressure of the fuel tank 100 can be reduced.

Meanwhile, when the speed of the vehicle is increased so that the internal pressure of the fuel tank 100 may be increased, if the internal pressure of the fuel tank 100 is beyond the allowable value range of the target pressure value of the fuel tank 100, the canister cut off valve 210 is open, so that external air is introduced into the fuel tank 100.

Thereafter, if the internal pressure of the fuel tank 100 is increased higher than the allowable value, the canister cut off valve 210 is closed.

As described above, if the internal pressure of the fuel tank 100 becomes higher than or lower than the allowable value during the pressure control operation of the controller 340, the controller 340 adjusts the internal pressure of the fuel tank 100 by using the canister purge valve 220 and the canister cut off valve 210.

The diagnosing part 350 diagnoses the leak of the fuel tank 100 based on the internal pressure of the fuel tank 100 when the vehicle is stopped.

The vehicle may be suddenly stopped in a state that a higher fuel pressure is maintained while the vehicle is being driven at a high speed. In this case, even if the vehicle is stopped, if the internal pressure of the fuel tank 100 is not reduced to the target pressure value, the diagnosing operation of the leak of the fuel tank 100 is not started. If the canister purge valve 220 is open, so that the internal pressure of the fuel tank 100 is lowered to the target pressure value, the diagnosing operation of the leak of the fuel tank 100 is preferably started.

In addition, when the vehicle is stopped, so that the diagnosing operation of the fuel tank 100 is started, a target pressure value for the diagnosing of the fuel tank 100 when the vehicle is stopped may be set differently from a target pressure value to be reduced during the driving the vehicle. Accordingly, the elapse of allowable time is determined without calculating the degree of the leak, so that the leak of the fuel tank 100 can be diagnosed.

In addition, the internal pressure of the fuel tank 100 when the engine is stopped may make a difference with the target pressure value due to various conditions. In order to determine the leak of the fuel tank 100 based on the increase rate of the pressure in the fuel tank 100, various holding times may be set according to pressure generated until the engine is stopped.

For example, if the pressure of the fuel tank 100 is dropped to a low value, it is possible to wait for “no leak” diagnosing for sufficient time. However, if the relative pressure of the fuel tank 100 has a high value when the vehicle is stopped, it is held only for a shorter time to wait for “no leak” diagnosing. That is, since the internal pressure of the fuel tank 100 is dropped within a small range, a time required to increase the pressure of the fuel tank 100 is relatively short.

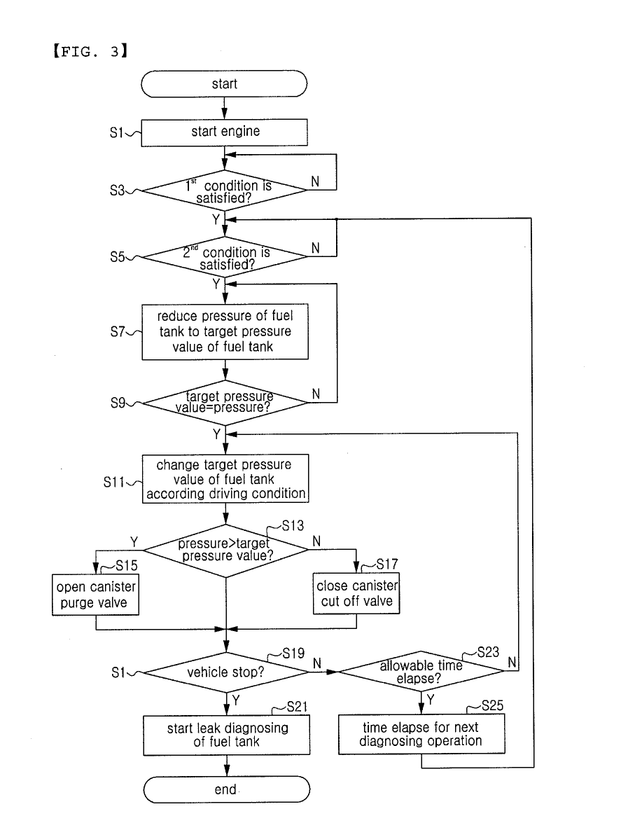

FIG. 3 is a flowchart showing the operating procedure of the apparatus of diagnosing the leakage of the fuel tank shown in FIG. 1. As shown in FIG. 3, in order to diagnose the leakage of the fuel tank 100, after the engine of a vehicle has been started, it is determined if the first condition to primarily check the status of basic parameters required to diagnose the leakage of the fuel tank 100 is satisfied (steps S1 to S3).

Thereafter, if the first condition is satisfied, it is determined if the second condition, which is required to determine the starting of the control operation of the internal pressure of the fuel tank 100 during the driving of the vehicle, is satisfied (step S5).

If the second condition is satisfied in step S5, the internal pressure of the fuel tank 100 is reduced to the target pressure value of the fuel tank 100 set according to the driving conditions of the vehicle (step S7). This reduced pressure is checked for compliance with the target pressure (step 59).

Accordingly, if the driving conditions of the vehicle (e.g., the speed of the vehicle) are changed while continuously performing a control operation of maintaining the internal pressure of the fuel tank 100 to the target pressure value, the target pressure value of the fuel tank 100 is changed (step S11).

As described above, if the pressure of the fuel tank 100 is greater than the changed target pressure value, the canister purge valve 220 is open so that the pressure of the fuel tank 100 is reduced (steps S13 to S15). In contrast, if the pressure of the fuel tank 100 is lower than the target pressure value, the canister cut off valve 210 is open, so that the pressure of the fuel tank 100 is increased (step S17).

Thereafter, if the vehicle is stopped, the diagnosing of the leakage of the fuel tank 100 is started based on the pressure of the fuel tank 100 formed through the above procedure (step S19 to S21).

Therefore, the leak diagnosing of the fuel tank 100 can be set through a conventional diagnosing process.

In step S19, if the vehicle is not stopped, it is determined according to the elapse of the allowable time whether the control operation for the pressure of the fuel tank 100 is continuously performed, or a next diagnosing procedure is started (step S23 to S25).

Although exemplary embodiments of the present invention have been described for illustrative purposes, those skilled in the art will appreciate that various modifications, additions and substitutions are possible, without departing from the scope and spirit of the invention as disclosed in the accompanying claims.

According to the present invention, the internal pressure of the fuel tank is controlled during the driving of the vehicle, so that the leak of the fuel tank is immediately diagnosed. Thus, the present invention is applicable in various fields in terms of sales and business and very useful in practice with high industrial applicability.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

12. A method of diagnosing a leak of a fuel tank of a vehicle, the method comprising:
determining a satisfaction of a first condition that is used to check a status of at least one basic parameter required to control a pressure of the fuel tank during a driving of the vehicle;
determining, if the first condition is satisfied, a satisfaction of a second condition that is used to determine whether a pressure control operation of the fuel tank is started;
adjusting, if the second condition is satisfied, a target pressure value of the fuel tank according to a driving condition of the vehicle; and
controlling a formation of the pressure in the fuel tank in accordance with the target pressure value, by an apparatus for diagnosing the leak of the fuel tank.

13. The method of claim 12, further comprising diagnosing the leak of the fuel tank based on the pressure of the fuel tank when the vehicle is stopped in order to diagnose the leak of the fuel tank.

14. The method of claim 12, wherein the first condition includes at least one of:
if an error occurs in at least one device to diagnose the leak of the fuel tank,
if fuel is cooled,
if an external temperature condition is satisfied when an engine is started,
if a battery voltage is effective,
if an amount of the fuel is effective, and
if the fuel is supplied.

15. The method of claim 1, wherein the second condition includes at least one of
if an opening of a canister purge valve is controlled step by step,
if the canister purge valve is at a maximum open level,
if the pressure of the fuel tank is in a preset allowable range,
if the pressure of the fuel tank is changed in a preset variation range, and
if an engine load is excessively formed to above a preset level.

16. The method of claim 12, wherein the step of controlling the formation of the pressure includes, if the pressure of the fuel tank is greater than the target pressure value, opening a canister purge valve so that the pressure of the fuel tank is reduced.

17. The method of claim 12, wherein the step of controlling the formation of the pressure includes, if the pressure of the fuel tank is lower than the target pressure value, opening a canister cut off valve so that the pressure of the fuel tank is increased.

18. The method of claim 12, wherein:
the step of controlling the formation of the pressure includes, if the pressure of the fuel tank is within a hysteresis based on the target pressure value, abstaining from performing an open control operation of one of a canister purge valve and a canister cut off valve, and
the step of controlling the formation of the pressure includes, if the pressure is out of the hysteresis based on the target pressure value, performing the open control operation of one of the canister purge valve and the canister cut off valve.

19. The method of claim 12, wherein the driving condition includes at least one of a vehicle speed, an amount of intake air, and an engine load.

20. The method of claim 13, wherein the diagnosing of the leak of the fuel tank includes:
holding, if the pressure of the fuel tank is not reduced to the target pressure value, the diagnosing of the leak of the fuel tank until a canister purge valve is open so that the pressure of the fuel tank reaches the target pressure value, wherein the target pressure value corresponds to when the vehicle is stopped.

21. An apparatus for diagnosing a leak of a fuel tank of a vehicle, the apparatus comprising:
a first determining part for determining a satisfaction of a first condition that is used to check a status of at least one basic parameter required to control a pressure of the fuel tank during a driving of the vehicle;
a second determining part for determining, if the first condition is satisfied, a satisfaction of a second condition that is used to determine whether a pressure control operation of the fuel tank is started;
an adjusting part for adjusting, if the second condition is satisfied, a target pressure value of the fuel tank according to a driving condition of the vehicle; and
a controller for controlling a formation of the pressure in the fuel tank in accordance with the target pressure value.

22. The apparatus of claim 21, further comprising a diagnosing part for diagnosing the leak of the fuel tank based on the pressure of the fuel tank when the vehicle is stopped.
